(19) United States
(12) Patent Application Publication
(10) Pub. No.: US 2015/0335150 A1
(43) Pub. Date: Nov. 26, 2015

(54) Mobile Permitting Laterally and Vertically Adjustable Displays

(71) Applicant: Samuel V. Frisby, Franklin, OH (US)

(72) Inventor: Samuel V. Frisby, Franklin, OH (US)

(21) Appl. No.: 14/718,173

(22) Filed: May 21, 2015

Related U.S. Application Data
(60) Provisional application No. 61/997,070, filed on May 22, 2014.

(51) Int. Cl. A47B 45/00; F16M 13/02

(52) U.S. Cl. CPC A47B 45/00; F16M 13/02

(57) ABSTRACT

Disclosed herein is a mobile for displaying an almost limitless variety items including artistic creations, memorabilia, ephemera, or even documents or renditions representing the prosaic and mundane. The mobile comprises essentially a box frame attachable to a planar surface and housing a plurality of reels with spring-loaded cables for suspending the displayed items vertically, in generally the same plane, against a typically nondescript backdrop, such as a wall. The displayed items can be suspended at various vertical distances from the box frame and arranged in an ordered or random fashion.

### CROSS-REFERENCE TO RELATED APPLICATION

This application claims the benefit of the filing date of U.S. Provisional Patent Application 61/997,070 filed May 22, 2014, which is hereby incorporated by reference.

### FIELD OF THE INVENTION

This invention relates generally to a method and device for displaying items of décor or interest, typically against the backdrop of a relatively plain or visually harmonious wall. More specifically, this invention relates to a mobile comprising a box frame attachable to a flat surface such as a ceiling or a wall, said box frame housing a plurality of reels of spring-loaded cables, and said cables having attachment means at their distal ends for easy attachment and removal of any of a variety of items of art or interest for display against the backdrop of a wall. Even more specifically, the spring-loaded reels permit the displayed items to be suspended and presented in an almost limitless variety of two-dimensional arrays against the designated backdrop.

### DESCRIPTION OF THE PRIOR ART

The patent art is replete with mobiles displaying items of amusement and interest while enhancing or personalizing room décor. For example, U.S. Pat. Nos. 4,567,682; 4,729,182 and 5,606,816 describe displays of photographs that can be hung vertically from a support mechanism, allowed to rotate freely and be exchanged with other photos from time to time. U.S. Pat. No. 5,068,535 describes a mobile having a number of detachable mobile elements to enable the user to re-balance the mobile after removing one or more of the mobile elements. And, U.S. Pat. No. 4,880,197 describes a mobile having an improved mounting mechanism with which the mobile hangs vertically without requiring a mounting arm of the mounting mechanism to be positioned in a specific orientation. Additionally, the mounting mechanism has a spring connector allowing vertical movement of the mobile relative to the mounting mechanism and stop surfaces on the mobile to limit vertical movement to a finite distance.

Notwithstanding the features and advantages of the mobiles described in the prior art, there remains a need for a mobile that will allow the user to create, alter and re-create a two-dimensional mobile while permitting an almost limitless variety of suspended and displayed items of art, interest and amusement.

### SUMMARY OF THE INVENTION

Generally disclosed and described herein is a mobile which comprises essentially a box frame containing a plurality of reels having spring-loaded cables. The cables are releasable from the reels and descend vertically from the box frame so that items of interest can be attached to the extended ends of the cables. Specifically disclosed herein is a mobile comprising a box frame wherein the box frame has top, bottom, front and back sides. The top and bottom sides contain a plurality of slots for the attachment of the reels and extension of the cables, respectively. The front side of the box frame is a valance; typically decorated and pivotally attached to one of the other sides of the frame, generally the top side. End sides are contemplated but are not essential to the function of the mobile.

Within the confines of the sides of the box frame are a plurality of reels having spring-loaded cables. As mentioned supra, the reels are attached to the slots in the top side of the frame, the slots providing some measure of lateral positioning. The spring loaded cables, when extended, are intended and designed to exit and extend from the frame via the slots in the bottom side of the frame. -The distal ends of the cables can be extended to a variety of lengths, limited only by the lengths of the cables, and are fitted with means for attaching items of interest, which become a part of and are the purpose of the mobile.

### BRIEF DESCRIPTION OF THE DRAWING

FIG. 1 is a front perspective view of the disclosed mobile sectioned to illustrate the indeterminate length of said mobile.

FIG. 2 is a sectioned disassembled front view of the mobile.

FIG. 3 is a sectioned rear view of the disassembled mobile.

FIG. 4 is an exploded view of the mobile illustrating the attachment of the reels; and

FIG. 5 is an enlarged cross-sectional view taken along line 5-5 of FIG. 1 depicting the location of all functional components of the assembled mobile.

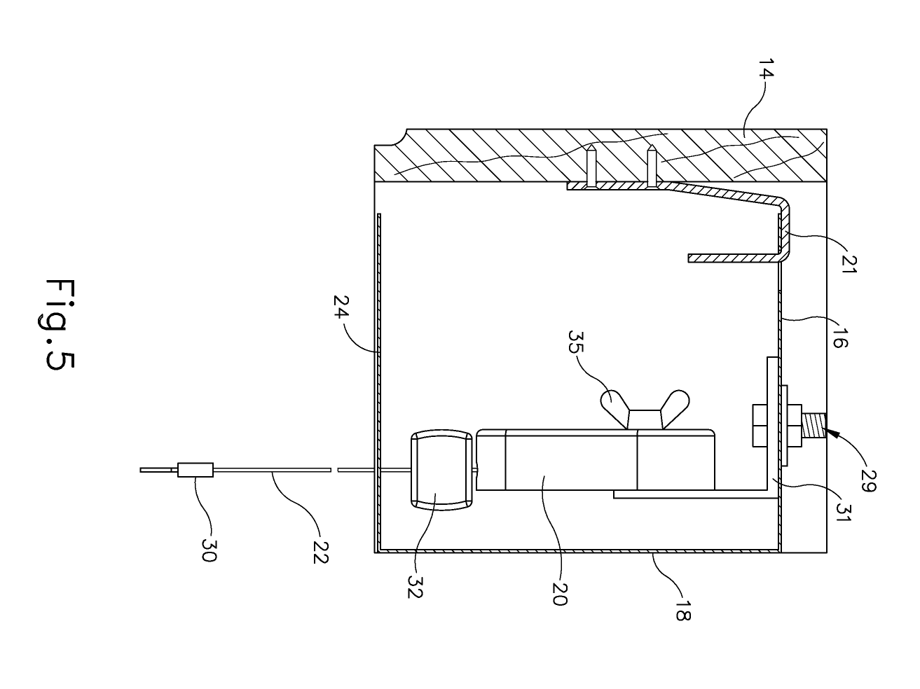

### DESCRIPTION OF THE PREFERRED EMBODIMENT

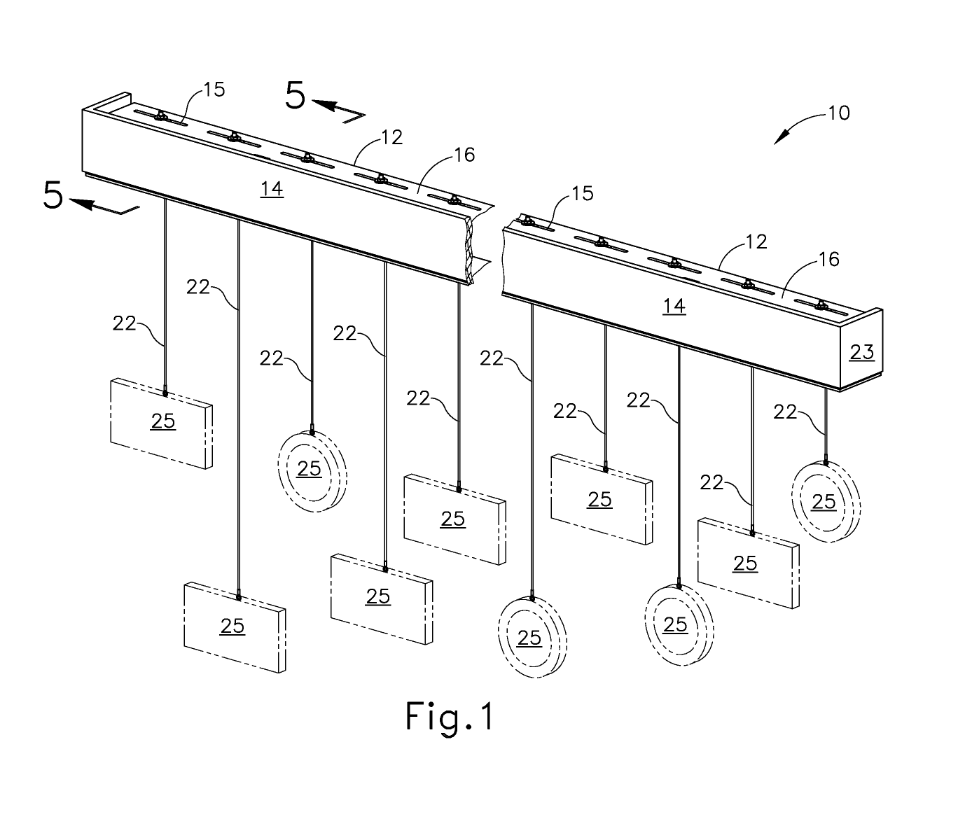

FIG. 1 of the drawing is a sectioned depiction of the mobile 10 illustrating the indeterminate length of the mobile and displaying items of interest 25. In its most basic embodiment, the disclosed mobile 10 is a four-sided box frame 12 housing a plurality of reels 20′ with spring-loaded cables 22 extending vertically from the box frame. The distal ends of the spring-loaded cables are fitted with means 30 for attaching items of interest 25 for décor or display.

More specifically, the box frame 12 is an elongated rectangular housing having top 16, bottom 24, front 14 and back 18 sides. The top 16 and bottom 24 sides contain a plurality of slots. The top slots 15 are for the attachment of the reels 20, and the bottom slots 26 permit the vertical extension and exit of the cables 22 from the reels to a predetermined or an arbitrary distance below the box frame 12.

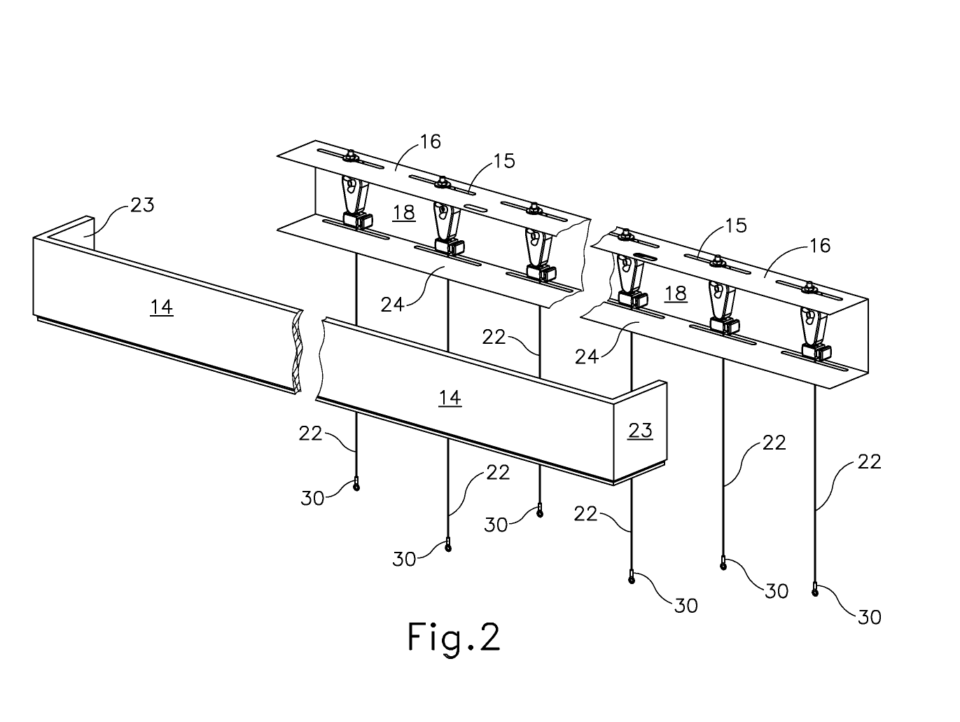

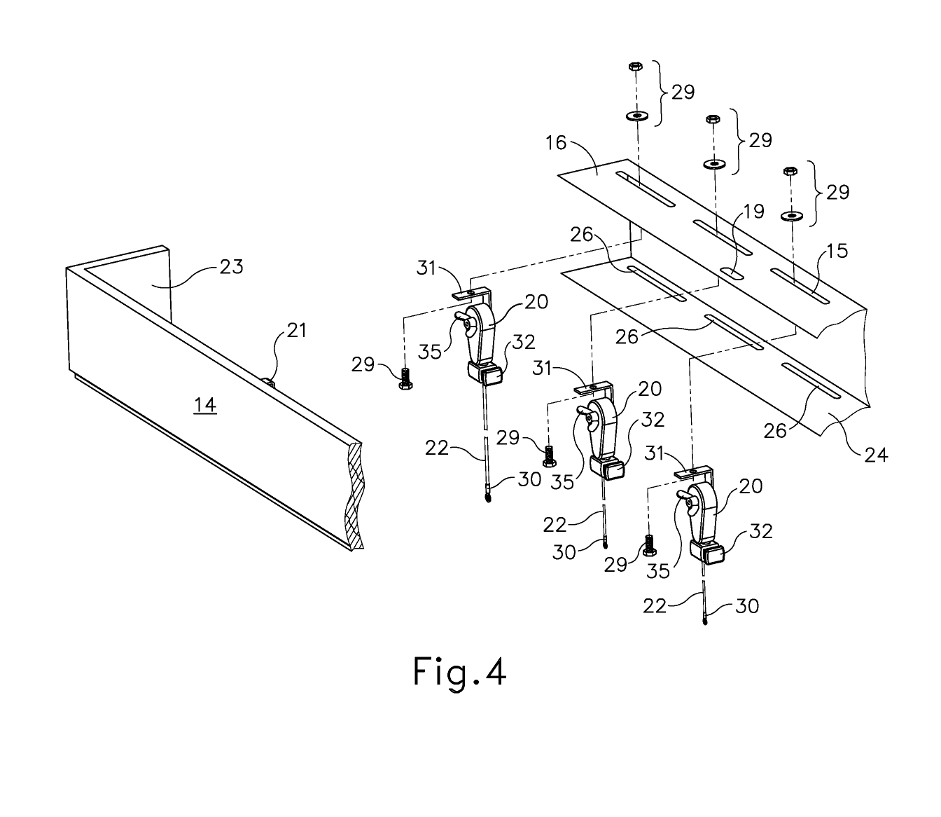

FIG. 2 is a disassembled view of the front side of the mobile 10. The front side 14 of the box frame 12 is shown detached from the top 16, bottom 24 and back 18 sides of the box frame 12. The front side 14 is termed a valance and is preferably pivotally attached or hinged to the other sides of the box frame 12. This permits easy access to the locking/release mechanisms 32 beneath the reels on the cables 22 enabling vertical extension and locking of the cables to the desired length. An opened front side 14 permits lateral positioning of the reels along slots 15 in the top side 16 of the box frame. Lateral adjustment of the reels 20 is easily effected by loosening and tightening the simple bolt, washer and nut fasteners 29 that attach the reels to the top side 16 of the box frame 12. FIG. 4, an exploded view of all the “working” elements of the mobile 10 as presented and sold to the customer for installation in the home, office or dorm room, presents a clear depiction of the positioning and attachment of the reels within the confines of the box frame 12.

Initially, an open front side of the box frame 12 facilitates the release and extension of the spring-loaded cables 22 through the bottom slots 26 in the bottom side 24 of the box frame to the desired vertical extension to a predetermined length. At the desired extension below the box frame, the locking/release mechanism 32 is utilized to lock the vertical positioning of the cable and the item of interest 25 is affixed via the attachment means 30. The attachment means 30 can be any of a variety of attachment mechanisms such as hooks, clips or the like.

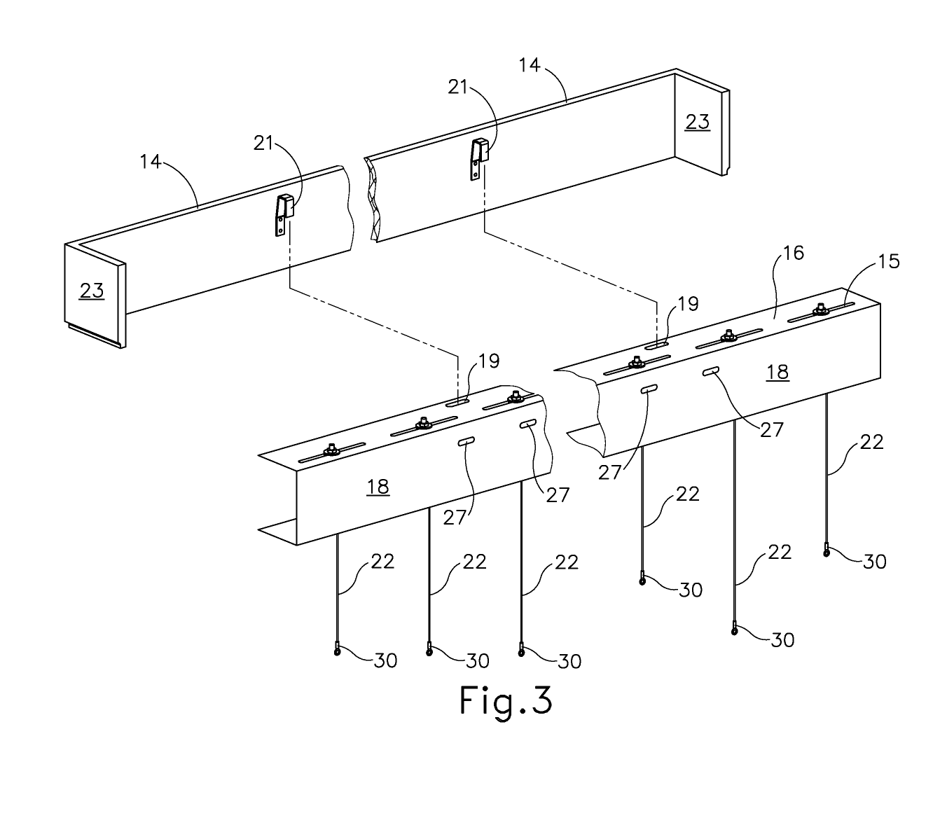

The front side 14, or valance, is preferably attached pivotally to the top side 16 of the box frame by means of a valance bracket 21, which is securely attached to the back side of the valance 14 and inserted into a bracket slot 19 in the top side 16 of the box frame 12. FIG. 3 illustrates the interaction between the valance 14 and the box frame 12. It is apparent that bracket 21, when inserted into bracket slot 19, permits the valance 14 to hang or be suspended from the top side 16 of the box frame and pivot 90° and extend perpendicularly from the box frame when opened. The pivoting valance opens and closes to permit and discourage access to the confines of the box frame 12.

Also apparent in FIG. 3 are attachment slots 27, which are positioned in the back side 18, and can be used to attach the box frame 12 of the mobile to a stable structure such as a wall. It should be noted that such attachment slots 27 could also be cut into the top side 16 of the box frame for handing the mobile 10 from a ceiling.

The valance 14, as shown, may also have end pieces or flanges 23 to completely enclose the box frame 12 and present a more elegant and “finished” appearance to the mobile 10.

The components of the mobile described herein can be fabricated from a variety of materials. Currently, the inventor is finding success and satisfaction by constructing the valance 14 from either wood or metal and with a simple mounting means for attachment to the frame box 12 as per the description, supra. The frame box 12 is ideally laser cut from 22 gauge steel then formed and painted. The cables 22 and reels 20 are preferably purchased as preassembled units from a vendor/manufacturer. The reel 20 is attached to the bracket 31 by wing nut 35 and the reel 20 and bracket 31 assembly, is attached to the frame box 12 with steel fastener 29. Currently, the reel assembly incorporates a 0.027″ diameter stainless steel cable, clear nylon coated to 0.034″ diameter, affixed to a constant force spring that evenly exerts 0.5 lbs. of force throughout the 48″ cable travel. As the cable is unwound from the reel, the spring exerts an opposite force of 0.5 lbs., which allows for the retraction of the cable onto the reel. To permit the cable to remain in the desired extended position, a 0.5 lb. spring loaded cable lock 32 is positioned between the mounted reel 20 and the bottom side 24. The cable lock 32 prevents the cable 22 from retracting when released after extension and will also provide an additional 0.5 lb. of frictional force that will then allow the user to display items (25) of interest weighing up to 1 lb. Items in excess of 1 lb. will overcome the spring force of 0.5 lbs. and the cable lock frictional force of 0.5 lbs. causing the cable to extend to its maximum 48″, which may not be desirable. To allow for items weighing more than 1 lb., the wing nut fasteners 35 can be easily hand-tightened to constrain the internal assembly of the reel, rendering it immovable, thus allowing objects of significant weight, e.g. 5 lbs., to be hung and held static as desired.

The mobile 10 sans suspended decorative items can be sold to consumers and hung in a limitless variety of residential and business environments. The disclosed mobile 10 allows the purchaser/user to quickly and easily create a montage of any theme or display without putting any more than a minimum number of attachment holes in the wall or ceiling. Currently the reels 20 and cables 22 have been selected to provide an ample number of suspending means that can extend to a vertical depth of 48″. Currently, the top side 16 of the box frame 12 has a plurality of 4″ slots 15 to which the reels are loosely bolted by fastener 29 allowing the user to adjust the spacing between the reels. Currently, the reels can be positioned anywhere from 2″ to 8″ apart. Objects of interest are currently being attached to the distal ends of the extended cables with a variety of attachment means 30 including hooks, clips, and the like.

While the foregoing is a complete and detailed description of the preferred embodiments of the disclosed mobile and its use for suspending items of interest vertically, but in the same plane, and in ordered or random fashion, it should be apparent that numerous variations and modifications of the disclosed mobile can be made and employed to implement the overall purpose of the disclosed mobile without deviating or departing from the spirit of the invention, which is fairly defined by the appended claims.

1. A mobile which comprises: an elongated box frame having front, back top and bottom sides and wherein said top and bottom sides contain a plurality of slots, and said front side is a valance pivotally attached to said box frame;
a plurality of reels positioned within said box frame sides and adjustably attached to said slots in said top side of said box frame, said reels having spring loaded cables proximally attached to said reels and extendable distally through said slots in said bottom sides of said box frame; and,
means at the distal ends of said spring loaded cables for the attachment of items of interest.

2. The mobile according to claim 1 wherein said valance is pivotally attached to said top side.

3. The mobile according to claim 1 having a pair of end sides.

4. The mobile according to claim 3 wherein the end sides are an integral part of said valence.

5. The mobile according to claim 1 further including a locking/release mechanism for fixing the vertical extension of said cables.
